(19) United States
(12) Patent Application Publication
(10) Pub. No.: US 2007/0041207 A1
(43) Pub. Date: Feb. 22, 2007

(54) Vehicle lamp

(75) Inventor: Hiroyuki Ishida, Shizuoka (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD.

(21) Appl. No.: 11/501,041

(22) Filed: Aug. 9, 2006

(30) Foreign Application Priority Data
Aug. 16, 2005 (JP) P.2005-236074

(51) Int. Cl. B60Q 1/00

(52) U.S. Cl. 362/538

(57) ABSTRACT

A vehicle lamp 10 including a basic lamp unit for forming a main light distribution pattern, and an additional lamp unit for forming auxiliary light distribution patterns. The additional lamp unit includes a projection lens, and a plurality of light source chips 72 to 77 disposed in the vicinity of a rear focal point F2 of the projection lens. Light beams emitted from the plurality of light source chips 72 to 77 are projected forwardly around an optical axis. The light source chips 72 to 77 can be turned on and off independently of one another, and longitudinal axes of light-emitting surfaces of the light source chips 72 to 77 are arranged generally radially with respect to the optical axis in accordance with a light distribution pattern of a light quantity-variable light distribution-type AFS that is to be projected forwardly.

This application claims foreign priority from Japanese Patent Application No. 2005-236074, filed Aug. 16, 2005, the entire contents of which are hereby incorporated by reference.

### BACKGROUND OF THE INVENTION

1. Technical Field

This invention relates to a vehicle lamp. Particularly, the vehicle lamp can be a lamp that is capable of selectively changing a light distribution pattern in accordance with a road condition, such as an urban area and an express highway; a weather condition, such as rain; and other conditions.

2. Background Art

Generally, in a projector-type vehicle headlamp, light emitted from a light source, such as a halogen bulb or a discharge bulb, is reflected by a reflector and is projected forward by a projection lens. Because the reflected light is partially blocked by a shade, a passing beam light distribution pattern having a cut-off line at an upper end edge is formed.

In recent years, headlamp systems called “an AFS (Adaptive Front Lighting System)” have been proposed for optimally controlling light in accordance with a traveling environment. These systems create a visual environment in which the vehicle can be driven more safely.

In one example of such an AFS, the whole passing-beam lamp unit is moved right and left by an electronic control in accordance with a steering angle of a steering wheel and a vehicle speed. In this kind of AFS, light is irradiated in a direction of travel of the vehicle. For example, when the vehicle travels on a curved road, a wide range of vision must be assured. This range of vision includes points at which the driver carefully looks during the driving so that the driver can quickly discover an obstacle, such as a man, an object, an animal and a parked car, so that the driver can take action to avoid the obstacle.

Also, in recent years, there have been developed light quantity-variable light distribution-type AFSs in which the amount of light, irradiated from a vehicle headlamp, can be varied so as to create an optimum light distribution in accordance with a road condition (such as a rural area and an express highway), a weather condition (such as rain and fog), and other conditions. In the future, it is expected that a safer traveling environment can be produced by using such a light quantity-variable light distribution-type AFS.

There is a vehicle headlamp for producing such a light quantity-variable light distribution-type AFS that employs semiconductor light sources, such as LEDs. In this vehicle headlamp, many semiconductor light sources are arranged in a matrix-like manner, and desired light sources of the semiconductor light sources are selectively turned on to create a light distribution pattern (see, for example, JP-A-2001-266620).

However, in the vehicle headlamp disclosed in JP-A-2001-266620, although the ability to adjust the light distribution pattern is high since many LEDs are selectively turned on and off, the turning-on and -off operation for each of many LEDs must be controlled. Therefore, a control circuit for turning-on and -off the LEDs becomes complicated, which increases cost. This invention has been made in view of the above problem.

### SUMMARY OF THE INVENTION

One aspect of the present invention is a vehicle lamp comprising a projection lens, and a plurality of light-emitting portions disposed in the vicinity of a rear focal point of the projection lens, wherein light beams emitted from the plurality of light-emitting portions are projected forwardly around an optical axis through the projection lens. At least one of the light-emitting portions can be turned on and off independently of the other light-emitting portions, and longitudinal axes of the light-emitting portions are arranged generally radially of the optical axis.

In this vehicle lamp, each of the light-emitting portions can have a generally rectangular shape.

In this vehicle lamp, the light-emitting portions can be formed respectively by light-emitting diodes.

In this vehicle lamp, the light-emitting portions can be formed by a light-emitting module having generally-rectangular light-emitting regions.

In this vehicle lamp, the light-emitting portions can be arranged generally radially of the optical axis around the focal point, and the light-emitting portions can be turned on and off independently of one another.

In this vehicle lamp, the light-emitting portions can include a first light-emitting portion extending generally horizontally, a second light-emitting portion extending generally vertically, and a third light-emitting portion extending generally diagonally between the first and second light-emitting portions.

In this vehicle lamp, the vehicle lamp can further include a lamp unit for emitting a passing beam, and the light beam projected from the projection lens can be selectively superimposed on a light distribution pattern formed by the passing beam.

The light-emitting portions may be formed within one light-emitting module, or a plurality of light-emitting modules may be arranged to form the light-emitting portions.

Here, each of the light-emitting portions can be formed by a semiconductor light source and particularly by a light-emitting diode.

The light-emitting portions can be formed by light-emitting chips each having a generally rectangular light-emitting region. The rectangular light-emitting region may be formed by one light-emitting chip or a plurality of light-emitting chips may be arranged to form a generally rectangular light-emitting region.

### BRIEF DESCRIPTION OF THE DRAWINGS

The advantages, nature, and various additional features of the invention will appear more fully upon consideration of the exemplary embodiments. The exemplary embodiments are set forth in the following drawings.

FIG. 1 is a schematic view showing a light distribution pattern projected forwardly from a vehicle in a exemplary embodiment of a light quantity-variable light distribution-type AFS of the present invention.

FIG. 2 is a horizontal cross-sectional view of a vehicle headlamp of the exemplary embodiment of the invention.

FIG. 3 is a perspective view showing a light source module of the vehicle headlamp.

FIG. 4 is a schematic plan view showing the light source module of the vehicle headlamp.

FIG. 5 is a view showing optical paths in a horizontal cross-section of an additional lamp unit.

FIG. 6 is a view showing the optical paths in a vertical cross-section of the additional lamp unit.

FIG. 7 is a schematic view showing a light distribution pattern projected by the vehicle headlamp.

FIG. 8 is a view showing a modified vehicle headlamp.

FIG. 9 is a view showing another modified vehicle headlamp.

FIG. 10 is a view of a further modified vehicle headlamp having an additional light source chip for forming overhead sign illumination light.

### DESCRIPTION OF THE EXEMPLARY EMBODIMENTS

Although the invention will be described with respect to an exemplary embodiments thereof, the following exemplary embodiments do not limit the invention.

First, before describing the vehicle lamp of this embodiment, a light quantity-variable light distribution-type AFS for effecting a light quantity-variable light distribution control in accordance with a road condition such as an urban area and an express highway, a weather condition such as rain, and other conditions will be described as a preparatory explanation.

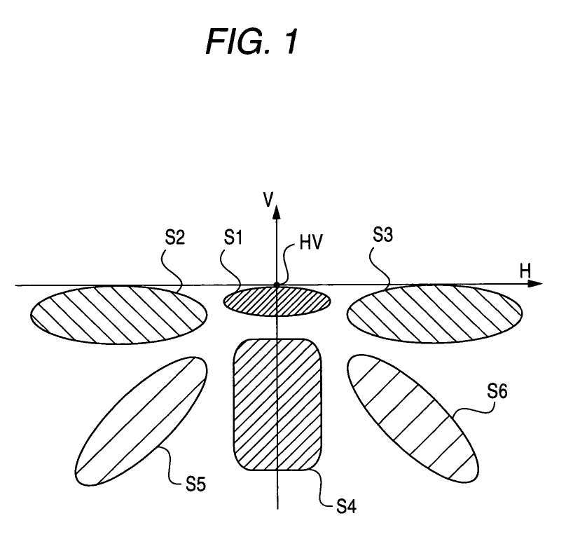

FIG. 1 is a schematic view showing a light distribution pattern projected forward from a vehicle in the light quantity-variable light distribution-type AFS of this embodiment.

A light distribution pattern S1 is formed by a light beam irradiated to the vicinity of a point HV or a region generally below it. When the light intensity at the region of this light distribution pattern S1 increases, visibility of distance objects is enhanced. Therefore, by selectively increasing the light quantity at the region of this light distribution pattern S1, a motorway mode, used for example at a motorway or the like, can be achieved.

Light distribution patterns S2 and S3 are formed respectively by light beams irradiated respectively to those regions disposed respectively at left and right sides of the light distribution pattern S1, and these light distribution patterns S2 and S3 extend horizontally left and right respectively with respect to the point HV. When the light intensity of the regions of these light distribution patterns S2 and S3 increases, lateral visibility is enhanced. Therefore, by selectively increasing the light quantity of the regions of these light distribution patterns S2 and S3, a town mode used for example when traveling at an urban area, an advancing direction-irradiating mode used when turning to the right or the left, and other modes can be achieved.

A light distribution pattern S4 is formed by a light beam irradiated to a region below the light distribution pattern S1 and extending downwardly with respect to the point HV. When the light intensity at the region of this light distribution pattern S4 decreases, reflection of light from a road surface as in a rain condition is suppressed so that the visibility can be enhanced. Therefore, by selectively decreasing the light quantity of the region of this light distribution pattern S4, a rain mode, used when traveling in a rain condition, can be achieved.

Light distribution patterns S5 and S6 are formed respectively at left and right sides of the light distribution pattern S4, and extend obliquely (or diagonally) downwardly respectively to the left and right with respect to the point HV. When the light intensity at the regions of these light distribution patterns S5 and S6 increases, the visibility of traffic signs, such as a center line and lane boundary lines painted on the road that extend in the advancing direction, is enhanced. Therefore, by selectively increasing the light quantity of the regions of these light distribution patterns S5 and S6 and also by selectively decreasing the light quantity of the region of the above-mentioned light distribution pattern S4, an optimum rain mode can be achieved.

The light quantity-variable light distribution-type AFS of this exemplary embodiment is constructed such that the light distribution patterns S1 to S6 are formed radially around the vicinity of the point HV (which is the intersection of a line H and a line V on a screen disposed in front of the vehicle) at a region generally below the line H. In this exemplary embodiment, this point is noted, and a plurality of light sources are arranged radially of a certain point in accordance with the light distribution pattern to be projected forwardly.

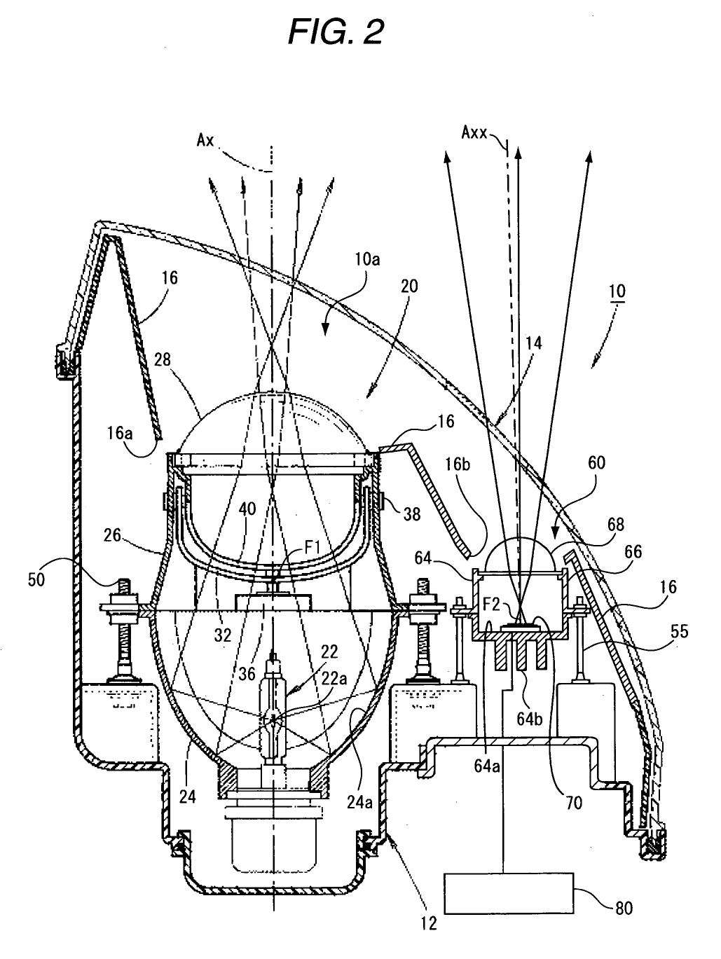

A specific example of the vehicle headlamp for realizing this light quantity-variable light distribution-type AFS will be described below with reference with FIGS. 2 to 7.

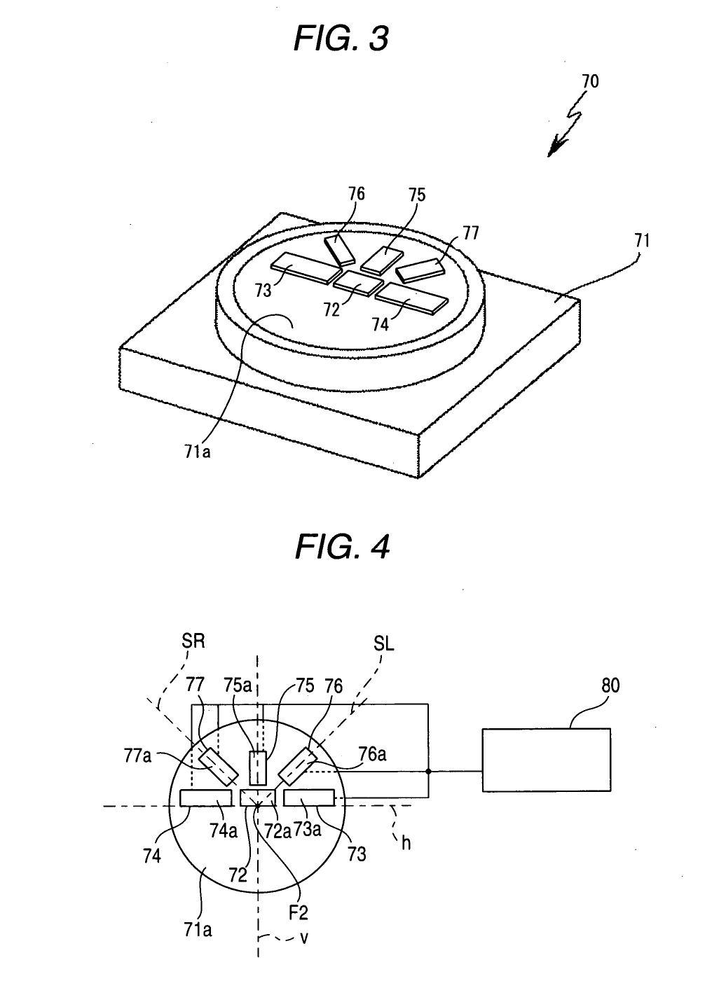

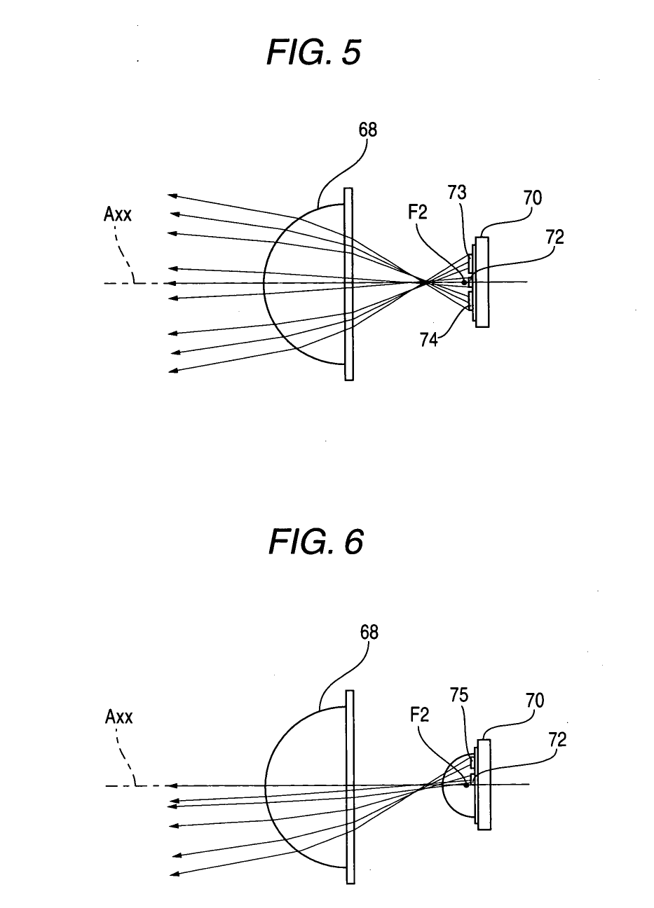

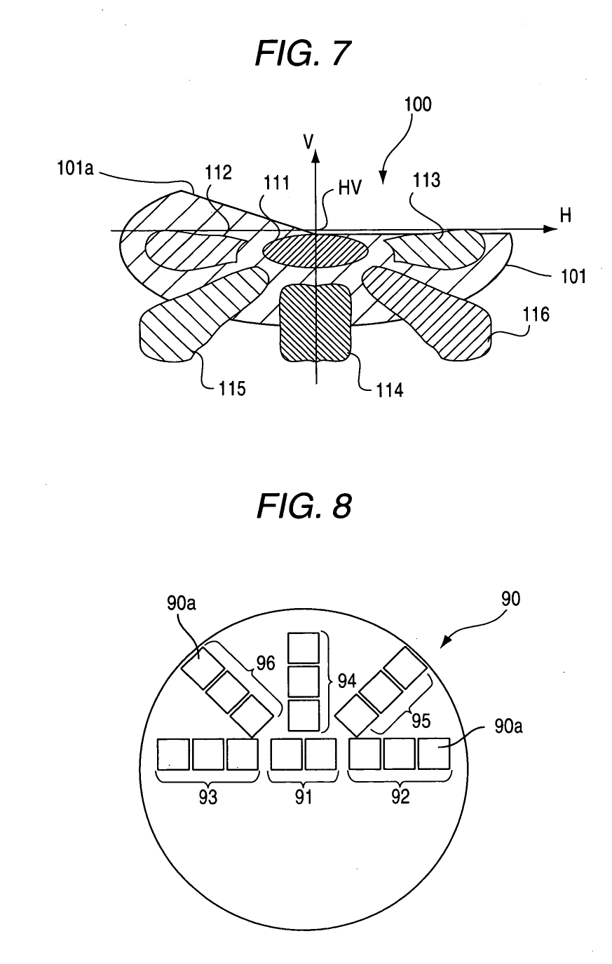

FIG. 2 is a horizontal cross-sectional view of the vehicle headlamp of this exemplary embodiment, FIG. 3 is a perspective view showing a light source module of the vehicle headlamp of this exemplary embodiment, and FIG. 4 is a schematic plan view thereof. FIG. 5 is a view showing optical paths in a horizontal cross-section of an additional lamp unit of this exemplary embodiment, FIG. 6 is a view showing the optical paths in a vertical cross-section thereof, and FIG. 7 is a schematic view showing a light distribution pattern projected by the vehicle headlamp of this exemplary embodiment.

FIG. 2 is the horizontal cross-sectional view of one exemplary embodiment of the vehicle headlamp of the invention.

As shown in FIG. 2, the vehicle headlamp 10 of this exemplary embodiment is a lamp which is mounted on a right side portion of a front end of the vehicle. In this vehicle headlamp 10, a lamp chamber 10a is formed by a lamp body 12 and a transparent, light-transmitting cover 14 attached to a front end opening portion of this lamp body 12, and a basic lamp unit 20 and an additional lamp unit 60 are received within this lamp chamber 10a and are arranged adjacent to each other in a left-right direction. An extension 16 is provided within the lamp chamber 10 generally along the light-transmitting cover 14, and tubular open portions 16a and 16b are formed respectively through those portions of the extension 16 corresponding respectively to the basic lamp unit 20 and the additional lamp unit 60, and are disposed generally in surrounding relation to the two lamp units 20 and 60, respectively.

The basic lamp unit 20 is constructed so as to be switched between a low beam (passing beam) and a high beam (running beam). In the low beam mode, the basic lamp unit 20 irradiates light for forming a low-beam light distribution pattern, and in the high beam mode, this lamp unit 20 irradiates light for forming a high-beam light distribution pattern.

On the other hand, the additional lamp unit 60 is selectively lit (or turned on) during the lighting (or turning-on) of the basic lamp unit 20 to irradiate light for forming additional light distribution patterns superimposed on the light distribution pattern formed by the basic lamp unit 20.

The detailed construction of the basic lamp unit 20, as well as the detailed construction of the additional lamp unit 60, will be described below.

First, the construction of the basic lamp unit 20 will be described.

This basic lamp unit 20 has an optical axis Ax extending in a forward-rearward direction of the vehicle and is supported on the lamp body 12 through an aiming mechanism 50 so as to be tilted in the upward-downward direction and the right-left direction. This basic lamp unit 20 is constructed such that when an aiming adjustment by the aiming mechanism 50 is not made, the optical axis Ax of the lamp unit 20 extends downwardly at an angle of approximately 0.5 to 0.6 degrees with respect to the horizontal direction in the forward-rearward direction of the vehicle.

As shown in FIG. 2, the basic lamp unit 20 is a projector-type lamp unit, and comprises a light source bulb 22, a reflector 24, a holder 26, a projection lens 28, a movable shade 32, and a shade-driving actuator 36.

The projection lens 28 comprises a plane-convex lens having a convex front surface and a flat rear surface, is disposed on the optical axis Ax, and projects an image (which is disposed on a focal plane including a rear focal point F1 of the projection lens 28) forwardly as an inverted image.

The light source bulb 22 is a discharge bulb, such as a metal halide bulb, having a discharge light-emitting portion 22a, and this light source bulb 22 is mounted on the reflector 24 in such a manner that its discharge light-emitting portion 22a is disposed rearwardly of the rear focal point F1 of the projection lens 28 in coaxial relation to the optical axis Ax.

The reflector 24 is constructed so as to reflect light from the discharge light-emitting portion 22a forward in a converging manner toward the optical axis Ax. The reflector 24 has a reflecting surface 24a, and the shape of a cross-section of this reflecting surface 24a including the optical axis Ax is generally elliptical, and the eccentricity of the reflecting surface 24a is gradually increasing from the vertical cross-section toward the horizontal cross-section. With this construction, in the vertical cross-section, light, emitted from the discharge light-emitting portion 22a and then reflected from the reflecting surface 24a, is converged at a position disposed slightly forwardly of the rear focal point F1, and in the horizontal cross-section, its converging position is moved to a position disposed considerably forwardly of the rear focal point F1.

The holder 26 extends forward from a front end opening portion of the reflector 24 and assumes a generally tubular shape. This holder 26 fixedly supports the reflector 24 at its rear end portion and fixedly supports the projection lens 28 at its front end portion.

The movable shade 32 is disposed within a generally lower half portion of the internal space of the holder 26 and is pivotally supported on the holder 26 by pivot pins 38 extending in the left-right direction. The movable shade 32 can be moved between a light-blocking position and a light-blocking cancellation position into which the movable shade 32 can be moved when it is pivotally moved rearwardly a predetermined angle from the light-blocking position.

A fixed shade 40 is formed integrally with the holder 26, and is disposed forward of the movable shade 32. This fixed shade 40 serves to prevent stray light, reflected by the reflector 24, from being incident on the projection lens 28.

When the movable shade 32 is located in the light-blocking position, its upper end edge 32a passes through the rear focal point F1 of the projection lens 28. Therefore, the movable shade 32 blocks part of the light reflected from the reflector 24, thereby eliminating most upwardly-directed light going forward from the projection lens 28. On the other hand, when the movable shade 32 is moved from the light-blocking position to the light-blocking cancellation position, its upper end edge 32a is displaced obliquely downwardly, thereby canceling the blocking of the reflected light from the reflector 24 (this condition is not shown).

The shade driving actuator 36 comprises a solenoid or the like. The shade driving actuator 36 transmits a reciprocal movement (in the forward-rearward direction) of its output shaft to the movable shade 32 so as to pivotally move this movable shade 32. When a beam changeover switch (not shown) is operated, the shade driving actuator 36 is driven to move its output shaft in the forward-rearward direction, thereby moving the movable shade 32 between the light-blocking position and the light-blocking cancellation position.

Next, the construction of the additional lamp unit 60 will be described.

The additional lamp unit 60 has an optical axis Axx extending in the forward-rearward direction of the vehicle, and is supported on the lamp body 12 through an aiming mechanism 55 so as to be tilted in the upward-downward direction and the right-left direction.

As shown in FIG. 2, the additional lamp unit 60 is a projector-type lamp unit employing semiconductor light sources and comprises the light source module 70, a light source unit holder 64, a lens holder 66, and a projection lens 68.

The light source unit holder 64 is a box-like metallic member that is open at its vehicle front-side portion and the light source module 70 is held on a bottom portion 64a of this light source unit holder 64. The lens holder 66 is mounted on the vehicle front-side portion of the light source unit holder 64 to cover a front opening thereof. Cooling fins 64b of a comb teeth-like shape, functioning as a heat sink, are formed on a vehicle rear-side portion of the light source unit holder 64.

The lens holder 66 is a tubular member which is open at its opposite ends, that is, in the vehicle forward and rearward directions, and is fixed to the light source unit holder 64 at its rear end portion. The projection lens 68 is fixed to the vehicle front-side opening portion of the lens holder 66 through a holding member (not shown).

The projection lens 68 comprises a plane-convex lens having a convex front surface and a flat rear surface, is disposed on the optical axis Axx, and projects an image (which is disposed on a focal plane including a rear focal point F2 of the projection lens 68) forwardly as an inverted image.

Next, the light source module 70 will be described.

As shown in FIGS. 3 and 4, the light source module 70 has a plurality of light source chips 72 to 77 (composed respectively of semiconductors) mounted on a base member 71. In order to protect the light source chips 72 to 77, a resin may be molded on these light source chips 72 to 77, or a transparent cover may be provided to cover the light source chips 72 to 77. In this exemplary embodiment, each of the plurality of light source chips 72 to 77 comprises a semiconductor light source element, such as a light-emitting diode (LED) or an organic EL element.

As shown in FIG. 4, these light source chips 72 to 77 are arranged on that portion of a mounting surface 71a of the base member 71 that is disposed above a central line thereof, that is, above an imaginary line h extending horizontally to vertically divide the mounting surface 71a into two sections in the upward-downward direction. The light source module 70 is mounted on the light source unit holder 64 in such a manner that the rear focal point F2 of the projection lens 68 coincides with the vicinity of the intersection of the imaginary line h and an imaginary line v extending vertically to divide the mounting surface 71a into two sections in the right-left direction. Also, the light source module 70 is mounted on the light source unit holder 64 in such a manner that the optical axis Axx, passing through the rear focal point F2, substantially perpendicularly intersects the mounting surface 71a. Thus, the light source chips 72 to 77 are disposed generally above the optical axis Axx.

As shown in FIG. 4, the light source chips 72 to 77 have respective light-emitting surfaces 72a to 77a of a generally rectangular shape. In this exemplary embodiment, the light-emitting surfaces 72a to 77a of the light source chips 72 to 77 form light-emitting portions, respectively.

The light source chip 72 is disposed in the vicinity of the intersection of the imaginary line h and the imaginary line v in such a manner that its longitudinal axis extends generally parallel to the imaginary line h, that is, generally in the direction of the width of the vehicle. The light source chips 73 and 74 are disposed respectively at left and right sides of the light source chip 72, the light source chip 75 is disposed at the upper side of the light source chip 72, and the light source chips 76 and 77 are disposed obliquely to the upper left and right of the light source chip 72, respectively. Namely, in this exemplary embodiment, the light source chips 73 to 77 are arranged radially of the light source chip 72, that is, radially of the optical axis Axx passing through the rear focal point F2 disposed in the vicinity of the intersection of the imaginary lines h and v.

The light source chips 73 and 74 are disposed respectively on left and right extension lines of the light source chip 72, and the longitudinal axes of their light-emitting surfaces 73a and 74a are generally parallel to the imaginary line h. With this arrangement, the light-emitting surfaces 73a and 74a extend generally radially with respect to the optical axis Axx.

The light source chip 75 is disposed on an upper extension line (the imaginary line v) of the light source chip 72, and the longitudinal axis of its light-emitting surface 75a is generally parallel to the imaginary line v. With this arrangement, the light-emitting surface 75a also extends radially with respect to the optical axis Axx.

The light source chips 76 and 77 are disposed respectively on extension lines (imaginary lines SL and SR) extending obliquely upwardly from the light source chip 72 respectively to the left and right, and the longitudinal axes of their light-emitting surfaces 76a and 77a are generally parallel to the imaginary lines SL and SR. With this arrangement, the light-emitting surfaces 76a and 77a also extend radially with respect to the optical axis Axx. Here, the angle between each of the imaginary lines SL and SR and the imaginary line h can be set, for example, to 45 degrees.

As will be appreciated from a comparison of FIG. 1 with FIG. 4, in the light quantity-variable light distribution-type AFS of FIG. 1, the light source chips 72 to 77 are arranged so that vertically and horizontally-inverted light distribution patterns (which are projected forward of the vehicle) can be obtained. Namely, in this exemplary embodiment, the light source chips 72 to 77 are arranged so as to correspond to a light quantity-variable light distribution-type AFS, such as that shown in FIG. 1.

Supply of electric power to the light source chips 72 to 77 is controlled by a light on/off controller 80 provided on the vehicle. The light on/off controller 80 can control the turning-on and -off of the light source chips 72 to 77 independently of one another. For example, under the control of the light on/off controller 80, only the light source chip 72 can be turned on, while the other light source chips 73 to 77 are kept in the OFF state.

Next, the optical paths of light emitted from the light source module 70 of this exemplary embodiment will be described with reference to FIGS. 5 and 6.

Light beams emitted from the light source chips 72 to 77 pass through the vicinity of the rear focal point F2, are incident on the rear surface of the projection lens 68, and then go forwardly from the front surface of this projection lens 68 as generally parallel rays of light. The light-emitting surfaces 72a to 77a of the light source chips 72 to 77 form respective original images that are to be projected forwardly, and the images, formed respectively by the light-emitting surfaces 72a to 77a, are projected forwardly in a vertically and horizontally inverted manner by the projection lens 68. Here, the light source chips 72 to 77 are disposed above the optical axis Axx, and therefore the forwardly-projected images are formed generally below the optical axis Axx as illustrated in FIG. 6 showing the optical paths in the vertical cross-section.

Next, the light distribution pattern, formed by the basic lamp unit 20 and the additional lamp unit 60, will be described. The following description is directed to the case where the basic lamp unit 20 is used in the low-beam mode.

FIG. 7 specifically shows the light distribution pattern 100 projected forwardly. The light distribution pattern 100, shown in FIG. 7, is projected on a screen installed, for example, at a distance of 25 m forward from the vehicle.

The light distribution pattern 100 is basically formed by a main light distribution pattern 101 formed by the basic lamp unit 20. This main light distribution pattern 101 has a cut-off line 101a corresponding to the shape of the upper end edge of the movable shade 32.

Light from the additional lamp unit 60 is projected so as to be superimposed locally on the main light distribution pattern 101, thereby locally increasing the light quantity of the main light distribution pattern 101.

More specifically, light, emitted from the light source chip 72, forms an auxiliary light distribution pattern 111 irradiated to the vicinity of the point HV or a region generally below it, thereby mainly increasing the light quantity of a hot zone of the main light distribution pattern 101.

Light beams, emitted from the light source chips 73 and 74, form respective auxiliary light distribution patterns 112 and 113 irradiated respectively to regions disposed respectively at left and right sides of the auxiliary light distribution pattern 111, and these light beams are projected such that in accordance with the arrangement and shape of the light-emitting surfaces 73a and 74a, the auxiliary light distribution patterns 112 and 113 extend long left and right in the horizontal direction with respect to the auxiliary light distribution pattern 111, respectively.

Light, emitted from the light source chip 75, forms an auxiliary light distribution pattern 114 irradiated to a region disposed below the auxiliary light distribution pattern 111. This light is projected such that in accordance with the disposition and shape of the light-emitting surface 75a, the auxiliary light distribution pattern 114 extends long downwardly with respect to the point HV.

Light beams, emitted from the light source chips 76 and 77, form respective auxiliary light distribution patterns 115 and 116. These patterns 115 and 116 are irradiated respectively to regions disposed between the auxiliary light distribution pattern 112 and the auxiliary light distribution pattern 114 and between the auxiliary light distribution pattern 113 and the auxiliary light distribution pattern 114. These light beams are projected such that, in accordance with the arrangement and shape of the light-emitting surfaces 76a and 77a, the auxiliary light distribution patterns 115 and 116 extend obliquely downwardly respectively to the left and right.

In this exemplary embodiment, under the control of the light on/off controller 80, the light source chips 72 to 77 are selectively turned on and off, thereby selectively projecting the auxiliary light distribution patterns 111 to 116 forwardly.

For example, when only the light source chip 72 is turned on, only the auxiliary light distribution pattern 111 is formed, and the intensity of light irradiated to the vicinity of the point HV or the region below it increases, thereby enhancing a distance visibility. By doing so, the motorway mode, used for example at a motorway or the like, can be achieved.

When one of the light source chips 73 and 74 is turned on, the auxiliary light distribution pattern 112 or 113 is formed, and the intensity of light irradiated leftward or rightward increases, so that an area in the advancing direction can be illuminated brightly during the travel of the vehicle. When traveling at an urban area or the like, both light source chips 73 and 74 are turned on to selectively increase the intensity of the laterally-directed light beams so that the town mode, in which lateral visibility is enhanced, can be achieved.

In a rain condition or the like, the light source chip 75 is switched from the ON-state to the OFF state, and then the light source chips 76 and 77 are turned on. By doing so, the region of the auxiliary light distribution pattern 114 is relatively darkened, and the reflected light from the road surface is decreased while the regions of the auxiliary light distribution patterns 115 and 116 are brightened. Therefore, the visibility of traffic signs, such as a center line and lane boundary lines painted on the road extending in the advancing direction, can be enhanced.

As described above, the vehicle headlamp 10 of this exemplary embodiment is provided with the basic lamp unit 20 that forms the main light distribution pattern 101 and the additional lamp unit 60 that forms the auxiliary light distribution patterns 111 to 116. The additional lamp unit 60 comprises the projection lens 68 and the plurality of light source chips 72 to 77 disposed in the vicinity of the rear focal point F2 of the projection lens 68. The light beams emitted from the plurality of light source chips 72 to 77 are projected forwardly around the optical axis Axx. The light source chips 72 to 77 can be turned on and off independently of one another, and the longitudinal axes of the light-emitting surfaces of the light source chips 72 to 77 are arranged radially with respect to the optical axis Axx in accordance with the shape of the light distribution pattern of the light quantity-variable light distribution-type AFS that is to be projected forwardly.

Therefore, in the vehicle headlamp 10 of this exemplary embodiment, by turning on and off the light source chips 72 to 77 to selectively form the auxiliary light distribution patterns 111 to 116, the light quantity of the main light distribution pattern 101 can be locally increased and decreased. Therefore, the light quantity-variable light distribution-type AFS for achieving the motorway mode, the rain mode, etc., can be suitably produced.

In addition, in the vehicle headlamp 10 of this exemplary embodiment, the longitudinal axes of the light-emitting surfaces of the light source chips 72 to 77 are arranged radially with respect to the optical axis Axx in accordance with the shape of the light distribution pattern of the light quantity-variable light distribution-type AFS that is to be projected forwardly. Therefore, the light quantity of those regions required in the light quantity-variable light distribution-type AFS can be suitably and easily increased and decreased. Furthermore, the light on/off controller 80 needs only to control the turning-on and -off of a small number of light source chips 72 to 77 independently of one another. Therefore, the turning-on and -off control is easy, and the light quantity-variable light distribution-type AFS can be produced without the need for a complicated control as required for controlling the turning-on and -off of many light source chips disclosed in JP-A-2001-266620.

In this exemplary embodiment, the light-emitting surfaces 72a to 77a of the light source chips 72 to 77 have a generally rectangular shape, and therefore the forwardly-projected light distribution patterns 111 to 116 can be suitably formed at the respective regions required in the light quantity-variable light distribution-type AFS. Incidentally, although the regions required in the light quantity-variable light distribution-type AFS can have a generally rectangular shape, other suitable shapes may be adopted.

In this exemplary embodiment, although the light-emitting module 70 comprises the light source chips 72 to 77 having the respective light-emitting surfaces 72a to 77a of a generally rectangular shape, the light-emitting module is not limited to this construction.

For example, as shown in FIG. 8, there may be used a light-emitting module 90 in which a plurality of light-emitting chips 90a of a generally square shape are arranged in a plurality of rows to form light-emitting portions 91 to 96. In this case, also, when the light on/off controller 80 is designed to control the turning-on and -off of the light-emitting portions 91 to 96 independently of one another, the light quantity-variable light distribution-type AFS can be produced without the need for a complicated turning-on and -off control for each light source chip 90a.

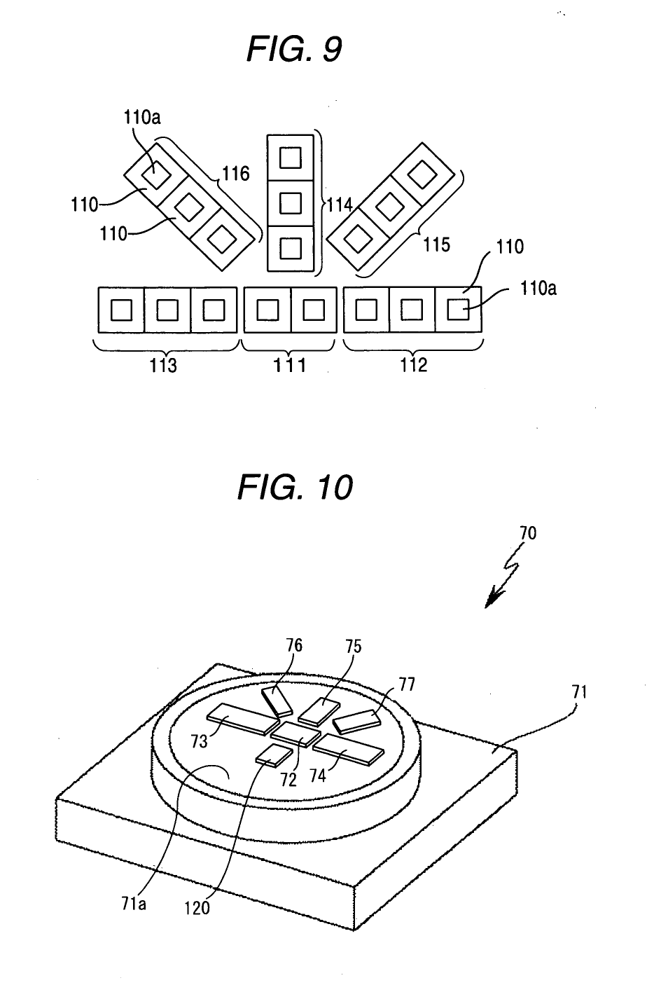

Furthermore, as shown in FIG. 9, light-emitting modules 110, each having one light source chip 110a, may be arranged in a plurality of rows. In this case the plurality of rows of light-emitting modules 110 are collectively used as light-emitting portions 111 to 116, respectively. In this case, when the light on/off controller 80 is designed to control the turning-on and -off of the light-emitting portions 111 to 116 independently of one another, the light quantity-variable light distribution-type AFS can be produced without the need for a complicated turning-on and -off control for each light source chip 110a.

As shown in FIG. 10, a light source chip 120 may be provided adjacent to the side of the light source chip 72 that opposes the light source chip 75. This light source chip 120 forms an overhead sign illumination region illuminated upwardly generally above the point HV. With this construction, the visibility of traffic signs or others objects provided along the road can be enhanced.

While the invention has been described with reference to the exemplary embodiments thereof, the technical scope of the invention is not restricted to the description of the exemplary embodiments. It is apparent to the skilled in the art that various changes or improvements can be made. It is apparent from the description of claims that the changed or improved configurations can also be included in the technical scope of the invention. For example, although the exemplary embodiment has described a headlamp, the invention is not limited to a headlamp and can be applied to other vehicle lamps and various beacon lights.

What is claimed is:

1. A vehicle lamp, comprising:
a projection lens, and
a plurality of light-emitting portions disposed in the vicinity of a rear focal point of said projection lens, wherein light beams, emitted from said plurality of light-emitting portions, are projected forwardly around an optical axis through said projection lens;
at least one of said light-emitting portions can be turned on and off independently of the other light-emitting portions, and longitudinal axes of said light-emitting portions are arranged generally radially with respect to said optical axis.

2. The vehicle lamp according to claim 1, wherein each of said light-emitting portions has a generally rectangular shape.

3. The vehicle lamp according to claim 1, wherein said light-emitting portions are formed respectively by light-emitting diodes.

4. The vehicle lamp according to claim 3, wherein said light-emitting portions are formed by a light-emitting module having generally-rectangular light-emitting regions.

5. The vehicle lamp according to claim 1, wherein said light-emitting portions are arranged generally radially with respect to said focal point, and said light-emitting portions can be turned on and off independently of one another.

6. The vehicle lamp according to claim 5, wherein said light-emitting portions include
a first light-emitting portion extending generally horizontally,
a second light-emitting portion extending generally vertically, and
a third light-emitting portion extending generally diagonally between said first and second light-emitting portions.

7. The vehicle lamp according to claim 1, wherein said vehicle lamp further includes a lamp unit for emitting a passing beam; and
the light beams, emitted from said projection lens, are projected to be selectively superimposed on a light distribution pattern formed by said passing beam.

8. The vehicle lamp according to claim 2, wherein said light-emitting portions are formed respectively by light-emitting diodes.

9. The vehicle lamp according to claim 8, wherein said light-emitting portions are formed by a light-emitting module having generally-rectangular light-emitting regions.

10. The vehicle lamp according to claim 2, wherein said light-emitting portions are arranged generally radially with respect to said focal point, and said light-emitting portions can be turned on and off independently of one another.

11. The vehicle lamp according to claim 10, wherein said light-emitting portions include
a first light-emitting portion extending generally horizontally,
a second light-emitting portion extending generally vertically, and
a third light-emitting portion extending generally diagonally between said first and second light-emitting portions.

12. The vehicle lamp according to claim 3, wherein said light-emitting portions are arranged generally radially with respect to said focal point, and said light-emitting portions can be turned on and off independently of one another.

13. The vehicle lamp according to claim 12, wherein said light-emitting portions include
a first light-emitting portion extending generally horizontally,
a second light-emitting portion extending generally vertically, and
a third light-emitting portion extending generally diagonally between said first and second light-emitting portions.

14. The vehicle lamp of claim 1, wherein the vehicle lamp is a vehicle headlamp.

15. The vehicle lamp of claim 2, wherein the vehicle lamp is a vehicle headlamp.

16. The vehicle lamp of claim 3, wherein the vehicle lamp is a vehicle headlamp.
